(19) United States
(12) Patent Application Publication
(10) Pub. No.: US 2008/0012994 A1
(43) Pub. Date: Jan. 17, 2008

(54) Television broadcast signal reception apparatus and antenna apparatus

(75) Inventor: Takehiro Onomatsu, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/730,861

(22) Filed: Apr. 4, 2007

(30) Foreign Application Priority Data
Apr. 5, 2006 (JP) 2006-103943

(51) Int. Cl. H04N 5/44; H01Q 21/30

(52) U.S. Cl. 348/725; 343/876; 348/E05.096

(57) ABSTRACT

To the broadcast signal of the first frequency band, the control unit, makes the selection unit select the first antenna and makes the channel setting unit set the channel and the reception direction of the broadcast signal, and, to the broadcast signal of the second frequency band, makes the selection unit select the second antenna and makes the channel setting unit set the channel of the broadcast, to simplify the channel auto scan.

### BACKGROUND OF THE INVENTION

1. Field of the Invention

The present invention relates to a television broadcast signal reception system capable of receiving television broadcast signals of the UHF band and the VHF band, and more particularly to a television broadcast signal reception apparatus having a channel auto scan (channel auto setting) function using a multi-directivity antenna and an antenna apparatus suitable for the television broadcast signal reception apparatus.

2. Related Art

Because plain areas are dotted with large cities and are provided with many broadcasting stations in the North American Continent, where the ATSC digital television broadcast (hereinafter abbreviated as a TV broadcast) is performed, TV broadcast signals are transmitted from various directions. In such an environment, a viewer receiving the TV broadcast signals is required to adjust the reception direction of an antenna into the direction of the broadcasting station broadcasting the program that the viewer wants to watch. Accordingly, a multi-directivity antenna, such as a smart antenna, has been put to practical use (see, for example, Patent Documents 1 and 2).

A technique pertaining to an auto scan function enabling the automatic setting of the reception direction of an antenna in which the TV broadcast signal of a channel that a viewer has selected can be received in the best state has been proposed (see, for example, Patent Documents 3 and 4). Because the position of the antenna on the side of a broadcasting station, i.e. the position of a broadcasting tower, does not generally change, the technique performs scans a plurality of directions (for example, 16 directions) to each channel, and sets the direction in which the reception state of the signal of a channel is the best as the reception direction of the channel.

The EIA-909 standard defines the smart antenna to have a reception direction in each direction obtained by dividing a circle into 16 directions. On the other hand, a digital TV broadcast signal reception apparatus in conformity with the EIA-909 standard is configured to be able to control reception directions into all of the 16 directions receivable with the smart antenna.

Patent Document 1: JP-A 2005-117608

Patent Document 2: JP-A 2001-036327 (Japanese Patent No. 3625155)

Patent Document 3: JP-A Hei 06-113220

Patent Document 4: JP-A 2001-68627

Now, in order to receive a broadcast signal from each broadcasting station with a television broadcast signal reception apparatus, it is necessary to execute a channel auto scan, but it is desirable for a viewer to complete the channel auto scan processing in a time as short as possible. However, if the auto scan of the channels is executed using the smart antenna and the auto scan function both of which are described in the techniques described in the above prior applications, the scans are performed to all of the 16 directions to each channel whether the TV broadcast signal is of the VHF band or of the UHF band. Consequently, the techniques have a problem of the necessity of a long time for setting.

On the other hand, the digitalization of ground wave broadcasts has rapidly advanced in recent years in each country of the world. Although the ground wave digital broadcasts are broadcasted in parallel to the existing UHF analog broadcasts, each of the assigned channel frequencies can simultaneously transmit five to six programs. The ground wave digital broadcasts consequently have an advantage capable of settling a frequency tightness problem by using vacant frequencies in various fields. Moreover, it is determined that the ground wave analog broadcasts are to be abolished and completely veer to the ground wave digital broadcasts in several years, and the broadcasts using the VHF band will be reduced to be stopped in future with the abolishment of the ground wave analog broadcasts.

Under such a situation, because channels that are not received (vacant channels) become many, the use of the techniques disclosed in the above prior applications in the setting of a channel of the VHF band would cost a superfluously waste time.

### SUMMARY OF THE INVENTION

Accordingly, it is an object of the present invention to provide a television broadcast signal reception apparatus capable of exceptionally shortening the time necessary for channel auto scan processing by simplifying the auto scan that has been conventionally executed even to the signals in the VHF band, and of setting the best reception direction in each channel by using a multi-directivity antenna for the signals in the UHF band.

The present invention has been developed to solve the above-described problem. In accordance with a first aspect of the invention, the television broadcast signal reception apparatus connected to an antenna apparatus including a first antenna capable of receiving a broadcast signal of a first frequency band, and a second antenna capable of receiving a broadcast signal of a second frequency band, the television broadcast signal reception apparatus comprises:

a selection unit for selecting either of the first antenna and the second antenna correspondingly to a frequency of a received broadcast signal;

a detection unit for detecting a reception level of a reception signal received by the first antenna or the second antenna;

a channel setting unit for setting a channel of a broadcast signal having the reception level equal to a predetermined level or more, the reception level detected by the detection unit, as a receivable channel; and

a control unit for controlling operations of the selection unit, the detection unit, and the channel setting unit, wherein

the channel setting unit includes:

a reception direction switching unit capable of switching the reception direction of the first antenna; and

a reception direction setting unit for setting a reception direction in which an optimum reception state can be obtained based on the reception levels in a plurality of reception directions, the reception levels detected by the detection unit when the reception direction of the first antenna is sequentially changed by the reception direction switching unit, wherein

the control unit, to the broadcast signal of the first frequency band, makes the selection unit select the first antenna and makes the channel setting unit set the channel and the reception direction of the broadcast signal, and, to the broadcast signal of the second frequency band, makes the selection unit select the second antenna and makes the channel setting unit set the channel of the broadcast signal (the setting of the reception direction is not performed). That is, the channel auto scan of the broadcast signals of the VHF band (second frequency band), which will be abolished in future, is simplified.

To put it concretely, the first antenna can be made to be a multi-directivity antenna (including a plurality of Yagi type antennas) capable of changing the reception direction thereof, and the second antenna can be made to be a unidirectional antenna (a rod antenna or a V-shaped antenna), which can receive broadcast signals from a single direction.

The second antenna is configured to be able to change the directivity by hand.

Thereby, the reception direction of the broadcast signal of the second frequency band is not automatically changed by the reception direction switching unit, but a viewer can arbitrarily change the reception direction by hand.

Moreover, the first frequency band is the frequency band equivalent to the UHF band (for example, 470 MHz-7705 MHz), and the second frequency band is the frequency band equivalent to the VHF band (for example, 90 MHz-222 MHz). That is, the channel auto scan by the smart antenna is executed only to the broadcast signals of the UHF band, and the auto scan by the smart antenna is not made to be executed to the broadcast signals of the VHF band, which will be abolished in future. Incidentally, the number of the broadcasting stations using the broadcast signals of the VHF band is decreasing year by year, and only several stations presently remain. Consequently, it is considerable that the television broadcast signal reception apparatus can sufficiently cope with the broadcast signals of the VHF band by the viewer's manual setting of the reception direction.

Alternatively, the frequency ranges of the first frequency band and the second frequency band may be made to be arbitrarily settable. For example, a channel operating as a boundary between the first frequency band and the second frequency band is made to be settable. Because the viewer can thereby determine the frequency band (channel) in which the channel auto scan by the smart antenna is executed, the channel auto scan can be executed more efficiently. Moreover, the upper limit of the first frequency band (UHF band) may be set.

In accordance with a second aspect of the invention, the antenna apparatus connected to the television broadcast signal reception apparatus, comprises:

a multi-directivity antenna capable of receiving broadcast signals of a first frequency band from many directions; and

a unidirectional antenna capable of receiving a broadcast signal of a second frequency band from a single direction, wherein

the antenna apparatus is connected to a television broadcast signal reception apparatus including:

a first switching unit for enabling selection control of the antennas receiving the broadcast signals by means of the television broadcast signal reception apparatus, and

a second switching unit for enabling switching control of reception directions of the multi-directivity antenna.

According to the present invention, because the television broadcast signal reception apparatus connected to an antenna apparatus including a first antenna capable of receiving a broadcast signal of a first frequency band (for example, the UHF band), and a second antenna (a unidirectional antenna) capable of receiving a broadcast signal of a second frequency band (for example, the VHF band), the television broadcast signal reception apparatus comprises: a selection unit for selecting either of the first antenna and the second antenna correspondingly to a frequency of a received broadcast signal; a detection unit for detecting a reception level of a reception signal received by the first antenna or the second antenna; a channel setting unit for setting a channel of a broadcast signal having the reception level equal to a predetermined level or more, the reception level detected by the detection unit, as a receivable channel; and a control unit for controlling operations of the selection unit, the detection unit, and the channel setting unit, wherein the channel setting unit includes:

a reception direction switching unit capable of switching the reception direction of the first antenna; and a reception direction setting unit for setting a reception direction in which an optimum reception state can be obtained based on the reception levels in a plurality of reception directions, the reception levels detected by the detection unit when the reception direction of the first antenna is sequentially changed by the reception direction switching unit, wherein

the control unit, to the broadcast signal of the first frequency band, makes the selection unit select the first antenna and makes the channel setting unit set the channel and the reception direction of the broadcast signal, and, to the broadcast signal of the second frequency band, makes the selection unit select the second antenna and makes the channel setting unit set only the channel of the broadcast signal, the time of the channel auto scan to the broadcast signals of the second frequency band is exceptionally shortened.

The dissatisfaction of the viewer to the execution of the channel auto scan can be thereby eliminated. Even if the number of broadcasting stations changes as the advance of the change to digital broadcasting, the viewer can comparatively easily execute the channel auto scan to receive a desired broadcast signal.

### BRIEF DESCRIPTION OF THE DRAWINGS

In the following, the preferable embodiment of the present invention will be described in detail with reference to the attached drawings. However, the scope of the present invention is not limited to the shown examples, in which:

FIG. 1 is a block diagram showing the functional configuration of a television broadcast signal reception system according to the present embodiment;

FIG. 2 is a perspective view showing the external appearance of an antenna apparatus 1 according to the present embodiment; and

FIG. 3 is a flow chart showing the channel auto scan processing in an STB 3.

### DETAILED DESCRIPTION OF THE PREFERRED EMBODIMENTS

In the following, the preferred embodiment of the present invention will be described with reference to the attached drawings. Incidentally, the scope of the invention is not limited to the shown examples.

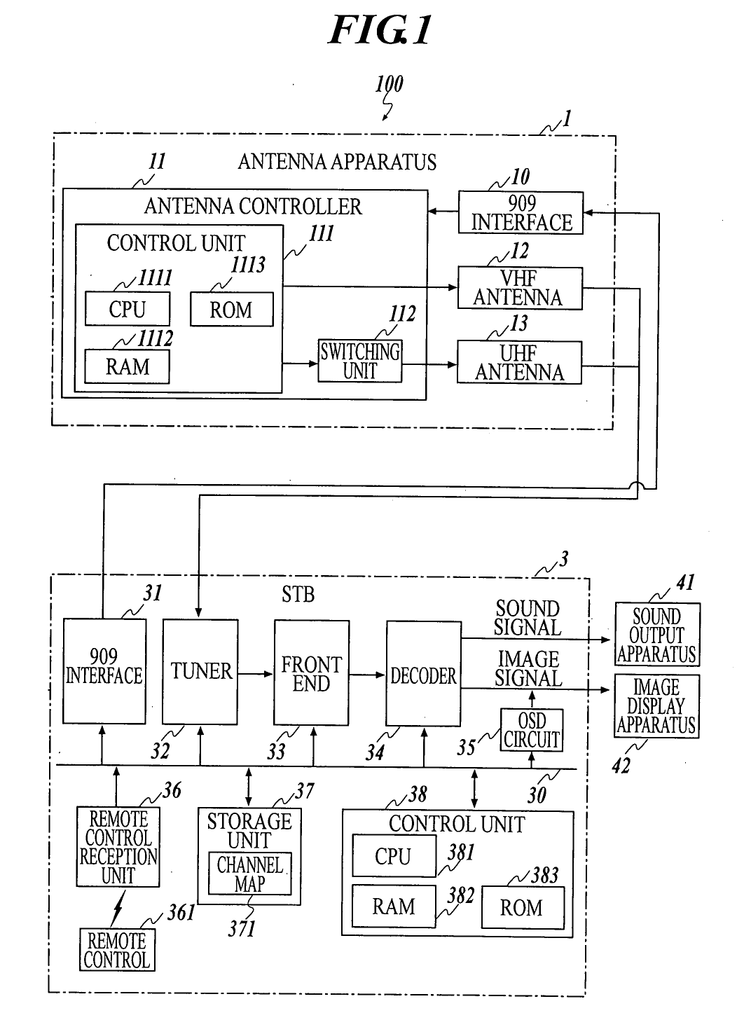

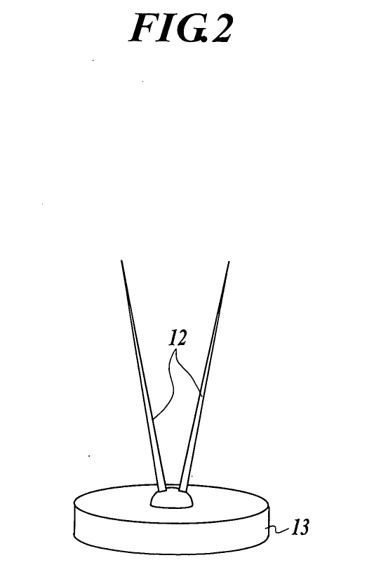

FIG. 1 is a block diagram showing the functional configuration of a television broadcast signal reception system, and FIG. 2 is a perspective view showing the external appearance of an antenna apparatus 1.

A television broadcast signal reception system 100 according to the present embodiment is configured to include the antenna apparatus 1 capable of receiving broadcast signals from a plurality of directions, and a set top box (hereinafter abbreviated to STB) 3 as a television broadcast signal reception apparatus connected to the antenna apparatus 1.

The antenna apparatus 1 is controlled by the STB 3 in accordance with, for example, a predetermined standard (such as the EIA/CEA-909).

The STB 3 controls, for example, the antenna apparatus 1 in accordance with a predetermined standard (such as the EIA/CEA-909), and receives a television broadcast signal (hereinafter referred to as a “TV broadcast signal”) through the antenna apparatus 1. Moreover, the STB 3 outputs a sound and an image based on a received TV broadcast signal.

In the present embodiment, it is supposed that the antenna apparatus 1 and the STB 3 are in conformity with the EIA/CEA-909 standard, as an example, and that the interface for performing the communication between the antenna apparatus 1 and the STB 3 is called as a 909 interface.

The antenna apparatus 1 is configured to include, for example, a 909 interface 10, an antenna controller 11, a UHF antenna 13 as a first antenna (multi-directivity antenna) capable of switching its directivity at the time of the reception of a TV broadcast signal in a first frequency band (for example, a UHF signal), and a VHF antenna 12 as a second antenna (unidirectional antenna) having fixed directivity at the time of the reception of a TV broadcast signal in a second frequency band (for example, a VHF signal). The VHF antenna 12 and the UHF antenna 13 are coupled with each other in the state of being freely attachable and detachable, for example, as shown in FIG. 2.

The VHF antenna 12 is, for example, an antenna configured to be able to receive a VHF signal transmitted from a transmitting tower or the like of a broadcasting station. To put it concretely, the VHF antenna 12 is the so-called rabbit antenna, and is attached to the UHF antenna 13 in the state of being freely attachable and detachable.

The UHF antenna 13 is, for example, an antenna configured to be able to receive a UHF signal transmitted from a transmitting tower or the like of a broadcasting station. To put it concretely, the UHF antenna 13 is the so-called smart antenna (Yagi type antenna), and the directivity thereof can be adjusted into a plurality of directions (for example, 16 directions).

The VHF antenna 12 and the UHF antenna 13 are connected to a tuner 32 of the STB 3. When the VHF antenna 12 and the UHF antenna 13 receives a TV broadcast signal, the VHF antenna 12 and the UHF antenna 13 perform gain control processing, such as the amplification of the TV broadcast signal by a predetermined gain, and output the TV broadcast signal (to put it concretely, a radio frequency (RF) signal) to the tuner 32.

The 909 interface 10 is connected with, for example, a 909 interface 31 (described below) of the STB 3, and performs the communication with the 909 interface 31 (described below) of the STB 3 based on a predetermined standard (for example, the EIA/CEA-909 or the like). The 909 interface 10 then receives channel information (described below) and the like for controlling the antenna apparatus 1 from the STB 3 to output the received information and the like to the antenna controller 11.

The antenna controller 11 is provided with, for example, a control unit 111 and a switching unit 112. Moreover, the control unit 111 is provided with, for example, a central processing unit (CPU) 1111, a random access memory (RAM) 1112, and a read only memory (ROM) 1113.

The CPU 1111 performs various control operations in accordance with various processing programs for the antenna controller 11, which programs are stored in the ROM 1113. The RAM 1112 includes a program storage region for expanding processing programs and the like, which programs and the like are executed by the CPU 1111, a data storage region for storing input data, processing results produced at the time of the execution of the processing programs mentioned above, and the like. The ROM 1113 stores a system program executable in the antenna controller 11, various processing programs executable on the system program, the data used at the time of the execution of these various processing programs, the data of processing results, which data has been arithmetically processed by the CPU 1111, and the like. Incidentally, the programs are stored in the ROM 1113 in the form of program codes readable by a computer. For example, the ROM 1113 stores an obtainment program, a judgment program, a selection program, and the like.

The CPU 1111 obtains, for example, the channel information transmitted from the 909 interface 31 of the STB 3 by executing the obtainment program stored in the ROM 1113. The channel information here means, for example, the information corresponding to the channel (virtual channel) tuned boy a user. To put it concretely, the channel information includes a physical channel number for judging which of a VHf signal and a UHF signal a TV broadcast signal corresponding to a tuned channel is, direction information pertaining to the direction of the directivity of an antenna, and gain information pertaining to the gain of the antenna.

Moreover, the CPU 1111 judges which of the VHF signal and the UHF signal a TV broadcast signal corresponding to the channel tuned by the user is by executing the judgment program. To put it concretely, the CPU 1111 judges that a TV broadcast signal is a VHF signal when a physical channel number α is a predetermined value (for example, α=17) or less, and judges that a TV broadcast signal is a UHF signal when the physical channel number a is larger than the predetermined value. The physical channel number is, for example, a number given so as to correspond to a frequency value of the frequency band in which the TV broadcast signal exist here, and the TV broadcast signal having a larger physical channel number exists in a frequency band having a larger frequency value. Moreover, the UHF signals exist in a frequency ban having larger frequency values in comparison with those of the frequency ban in which the VHF signals exist. It can be consequently judged by a physical channel number which of a VHF signal and a UHF signal a TV broadcast signal is.

Furthermore, the CPU 1111 selects either of the VHF antenna 12 and the UHF antenna 13 according to the frequency band (physical channel number) to which the TV broadcast signal corresponding to the tuned channel belongs by executing the selection program, and the CPU 1111 makes the selected antenna 12 or 13 receive the TV broadcast signal. That is, if a user tunes a channel corresponding to a VHF signal, the CPU 1111 selects the VHF antenna 12 to receive the TV broadcast signal, and if the user tunes the channel corresponding to a UHF signal, the CPU 1111 selects the UHF antenna 13 to receive the TV broadcast signal.

If the UHF antenna 13 is, for example, selected as the reception antenna in accordance with a control signal input from the control unit 111, the switching unit 112 switches the directivity of the UHF antenna 13 based on the direction information.

Incidentally, the VHF antenna 12 is simply configured to have the reception sensitivity for the VHF band, and is not unable to receive the UHF signals. Similarly, the UHF antenna 13 is simply configured to have the reception sensitivity for the UHF band, and is not unable to receive the VHF signals. Consequently, for example, if the VHF antenna 12 is removed, the antenna apparatus 1 may, for example, automatically or manually recognize the state of the removal of the VHF antenna 12, and may receive a VHF signal with the UHF antenna 13 if the TV broadcast signal corresponding to a tuned channel is a VHF signal.

The STB 3 is configured to include, for example, the 909 interface 31, the tuner 32, a front end 33, a decoder 34, an OSD circuit 35, a remote control reception unit 36, a storage unit 37, and a control unit 38. Each unit is connected with one another through a bus 30.

Moreover, the STB 3 is provided with, for example, a remote controller (hereinafter referred to as a remote control) 361 for the STB 3, which remote control 361 can communicate with the remote control reception unit 36.

The 909 interface 31 is connected with, for example, the 909 interface 10 of the antenna apparatus 1, and performs the communication with the 909 interface 10 of the antenna apparatus 1 based on a predetermined standard (for example, the EIA/CEA-909 or the like) in accordance with a control signal input from the control unit 38 to transmit channel information and the like to the antenna apparatus 1.

The tuner 32 is connected with the VHF antenna 12 and the UHF antenna 13 of the antenna apparatus 1, and obtains a TV broadcast signal corresponding to a channel (the channel tuned by a user) among the TV broadcast signals output from the VHF antenna 12 or the UHF antenna 13, for example, in accordance with a control signal input from the control unit 38, and outputs the obtained signal to the front end 33.

The front end 33 converts a TV broadcast signal output from the tuner 32 into an intermediate frequency signal, for example, in accordance with a control signal input from the control unit 38 to output the converted signal to the decoder 34.

The decoder 34 performs the processing according to a predetermined file format (for example, Moving Picture Experts Group phase 2 (MPEG-2) format or the like) to a TV broadcast signal output from the front end 33, for example, in accordance with a control signal input from the control unit 38, and thereby separates the TV broadcast signal into a sound signal and an image signal to perform their decoding. The decoder 34 outputs the decoded sound signal to a sound output apparatus 41, and outputs the decoded image signal to an image display apparatus 42.

The OSD circuit 35 synthesizes an OSD display signal for making the image display apparatus 42 perform predetermined on-screen display (OSD display) with an image signal output from the decoder 34 to the image display apparatus 42, for example, in accordance with a control signal input from the control unit 38.

The sound output apparatus 41 is, for example, speaker equipment or the like connected to the STB 3, and outputs a sound corresponding to the sound data based on a sound signal output from the decoder 34. The image display apparatus 42 is, for example, liquid crystal display equipment or the like connected to the STB 3, and displays an image corresponding to the image data based on an image signal output from the decoder 34, and an image corresponding to the image data based on an image signal that is output from the decoder 34 and is synthesized with an OSD display signal (described below) by the OSD circuit 37.

The remote control reception unit 36 receives various signals transmitted from, for example, the remote control 361, and outputs various sorts of data based on the various signals to the control unit 38. The remote control 361 includes, for example, a channel key and a channel up/down key, which are operated at the time of specifying a tuned channel, and transmits a signal corresponding to a user's key operation to the remote control reception unit 36.

The storage unit 37 is composed of, for example, a magnetic storage medium, an optical storage medium or a semiconductor memory, and stores a channel map 371 and the like.

The channel map 371 stores, for example, channel information and the like. To put it concretely, the channel map 371 associates virtual channel numbers assigned to the channel key and the channel up/down key of the remote control 381, physical channel numbers, direction information pertaining to the directions of the directivity of the antennas, gain information pertaining to the gains of the antennas, and the like with one another, and stores the associated information and the like therein. The information stored in the channel map 391 is, for example, determined in the initialization processing of the antenna system 100, and is stored in the channel map 391.

The control unit 38 is composed of, for example, a CPU 381, a RAM 382, and a ROM 383. The CPU 381 performs various control operations in accordance with various processing programs for the STB 3, which programs are stored in the ROM 383. The RAM 382 is provided with a program storage region for expanding the processing program and the like executed by the CPU 381, a data storage region for storing input data and the processing results produced at the time of the execution of the processing program mentioned above, and the like. The ROM 383 stores a system program executable in the STB 3, various processing programs executable in the system program, data used at the time of the execution of these various processing programs, the data of various results arithmetically processed by the CPU 381, and the like. Incidentally, the programs are stored in the ROM 383 in the form of program codes readable by a computer. For example, the ROM 383 stores a transmission program enabling the realization of the function of transmitting channel information to the antenna apparatus 1 through the 909 interface 31, and the like.

For example, when a channel is tuned by a user's key operation of the remote control 361 or the like, the CPU 381 obtains the channel information (the physical channel number, the direction information, the gain information and the like) corresponding to the channel number (virtual channel number) of the channel from the channel map 391 of the storage unit 39 to transmit the obtained channel information to the antenna apparatus 1 through the 909 interface 31 by executing the transmission program.

Moreover, the control unit 38 executes the processing as a selection unit for controlling the antenna apparatus 1 to select either of the UHF antenna (multi-directivity antenna, first antenna) 13 and the VHF antenna (unidirectional antenna, second antenna) 12 according to the frequency of a received TV broadcast signal, a detection unit for detecting the reception level of the TV broadcast signal received by the UHF antenna 13 or the VHF antenna 12, and a channel setting unit for setting the channel of the TV broadcast signal having the reception level, detected by the detection unit, of the predetermined value or more as a receivable channel.

The television broadcast signal reception system 100 according to the present embodiment is configured to include the antenna apparatus 1 and the STB 3 as described above. Incidentally, it is supposed that the channels receivable by the antenna apparatus 1 are, for example, 1 Ch to 69 Ch, and that 1 Ch to 17 Ch belong to the VHF band and 18 Ch to 69 Ch belong to the UHF band among them.

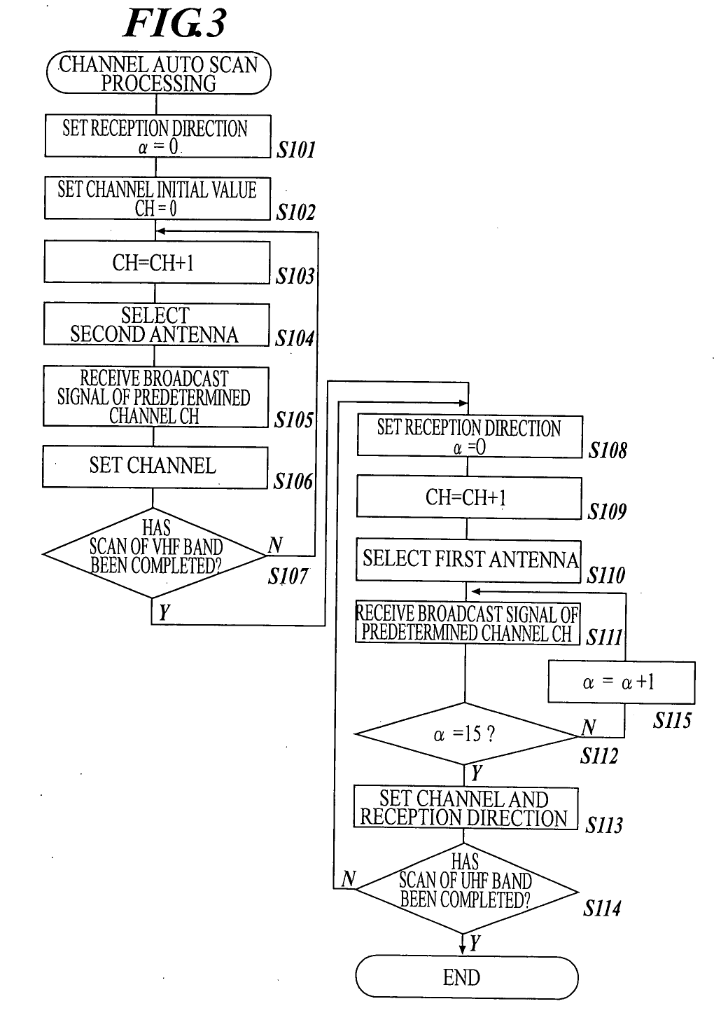

FIG. 3 is a flow chart showing the channel auto scan (channel auto setting) processing in the STB 3. The channel auto scan processing is performed by, for example, the execution of a predetermined program by the control unit 38 based on an input operation from the remote control 361.

First, when the channel auto scan processing is started, a reception direction is initialized at a step S101. For example, a reception direction α is set to 0. Incidentally, because the reception direction is a single direction to the TV broadcast signal of the VHF band, the reception direction does not change, but the reception direction α is set to 0 for convenience.

Next, a channel is initialized at a step S102. For example, a channel number CH is set to 0. One is added to the channel number at a step S103. That is, the channel number becomes: CH=1. Next, the VHF antenna (unidirectional antenna, second antenna) is selected as the reception antenna (selection unit) at a step S104.

A TV broadcast signal corresponding to a predetermined channel is then received at a step S105. Next, if a reception level equal to the predetermined level or more has been able to be obtained to the TV broadcast signal of the channel, the channel is set as a receivable channel at a step S106 (detection unit, channel setting unit).

The channel setting to one TV broadcast signal of the VHF band ends by the above processing.

Next, it is judged whether all channel settings have been completed or not, that is whether the channel number CH is 17 or not, as for the channels corresponding to the TV broadcast signals of the VHF band (for example, 1 Ch to 17 Ch) at a step S107. If it is then judged that the channel number CH is not 17, the processing shifts to the step S103. One is added to the channel number, and channel setting is performed to the next channel.

On the other hand, if it is judged that the channel number CH is 17 at the step S107, the channel auto scan of the broadcast signals of the VHF band is completed. The processing then shifts to that at a step S108, and the channel auto scan to the TV broadcast signals of the UHF band is started.

First, the reception direction is initialized at the step S108. For example, the reception direction α is set to 0. Incidentally, because the reception direction is changed into 16 directions to the TV broadcast signals of the UHF band, the reception direction α takes the values of 0-15.

Next, one is added to the channel number at a step S109. That is, because the channel number CH is 17 at the time point when the channel auto scan to the TV broadcast signals of the VHF band has been completed, the addition of one to the channel number results in CH=18. Next, the UHF antenna (multi-directivity antenna, first antenna) is selected as the reception antenna at a step S110 (selection unit).

A TV broadcast signal corresponding to a predetermined channel is then received at a step S111. Next, it is judged whether the reception processing has been performed into 16 directions or not, namely whether the reception direction α is 15 or not, at a step S112. If it is judged that the reception direction α is not 15 at the step S112, one is added to the reception direction α at a step S115, and the processing at and after the step S111 is executed (reception direction switching unit).

On the other hand, if it is judged that the reception direction α is 15 at the Step S112, the processing shifts to that at a step S113. Next, if the reception level equal to the predetermined value or more is obtained as to the TV broadcast signal of the channel at the step S113, the channel is set as the receivable channel (detection unit, channel setting unit). At the same time, the reception direction in which the optimum reception state can be obtained is set based on the reception levels to the plurality of reception directions detected at the time of sequential changing of the reception directions (α=0-15) (reception direction setting unit).

By the processing mentioned above, the channel setting of one TV broadcast signal of the UHF band ends.

Next, it is judged whether all of the channel settings to the channels (for example, 18 Ch to 69 Ch) corresponding to the TV broadcast signals of the UHF band have been completed or not, namely whether the channel number CH has become 69 or not, at a step S114. If it is then judged that the channel number CH is not 69, the processing shifts to that at the step S108. The reception direction is initialized, and one is added to the channel number at the step S109 to perform the channel setting to the next channel.

On the other hand, if it is judged that the channel number CH is 69 at the step S114, then the channel auto scan of the TV broadcast signals of the UHF band has been completed, and the channel auto scan processing ends at that time.

As described above, in the present embodiment, the channel and the reception direction (α=0-15) of a broadcast signal among the TV broadcast signals (18-69 channels) of the UHF band are set based on the reception level of a reception signal obtained when the UHF antenna 13 is selected, and on the other hand, only the channel of a broadcast signal among the TV broadcast signals (1-17 channels) of the VHF band is set based on the reception level of a reception signal obtained when the VHF antenna 12 is selected. That is, the reception directions of the TV broadcast signals in the VHF band, which will be abolished in future, are set to be one direction determined by the VHF antenna 12, and consequently the channel auto scan is simplified.

Incidentally, the number of the broadcasting stations using the TV broadcast signals of the VHF band is decreasing year by year, and several stations presently remain. Consequently, it is conceivable that the TV broadcast signals of the VHF band can be sufficiently coped with by the viewer's manual setting of their reception directions.

As described above, by the STB 3 according to the present embodiment, the time of the channel auto scan of the TV broadcast signals in the VHF band is exceptionally shortened. Consequently, the dissatisfaction of a viewer to the execution of the channel auto scan, can be eliminated. Hence, even if the number of broadcasting stations changes as the change to digital broadcasting advances, a viewer can comparatively easily execute the channel auto scan, and can be put in the state to be able to receive a desired TV broadcast signal.

Although the invention devised by the inventor of the present invention has been concretely described above based on the embodiment, the present invention is not limited to the embodiment, but it is possible to change the embodiment without departing from the scope of the invention.

For example, in the embodiment, the VHF antenna 12 is selected to the TV broadcast signals (1-17 channels) in the VHF band, and the UHF antenna 13 is selected to the TV broadcast signals (18-69 channels) in the UHF band. But, the frequency band in which the VHF antenna 12 is used and the frequency band in which the UHF antenna 13 is used may be adapted to be set by a viewer.

To put it concretely, a channel operating as a boundary between the UHF band (first frequency band) and the VHF band (second frequency band) is made to be able to be set. For example, if 1-20 channels are set as the VHF band, the number of the channels to which the auto scan of the VHF antenna 12 is performed increases, and the number of the channels to which the auto scan of the UHF antenna 13 is performed decreases. Consequently, the time necessary for the channel auto scan processing is further shortened. Because a viewer can determine the frequency bands (physical channels) to which the channel auto scan of each of the antennas 12 and 13 is performed in this way, the channel auto scan processing can be more efficiently executed.

Moreover, the upper limit of the first frequency band (UHF band) may be lowered (for example, the physical channels of the first frequency band are set to be 18-65 channels), and the lower limit of the second frequency band (VHF band) may be raised (for example, the physical channels of the second frequency bands are set to be 5-17 channels).

What is claimed is:

1. A television broadcast signal reception apparatus connected to an antenna apparatus including a first antenna capable of receiving broadcast signals of a UHF band from many directions, and a second antenna capable of receiving a broadcast signal of a VHF band from a single direction, the second antenna changeable its directivity with a hand, the television broadcast signal reception apparatus comprising:
a selection unit for selecting either of the first antenna and the second antenna correspondingly to a frequency of a received broadcast signal;
a detection unit for detecting a reception level of a reception signal received by the first antenna or the second antenna;
a channel setting unit for setting a channel of a broadcast signal having the reception level equal to a predetermined level or more, the reception level detected by the detection unit, as a receivable channel; and
a control unit for controlling operations of the selection unit, the detection unit, and the channel setting unit, wherein
the channel setting unit includes:
a reception direction switching unit capable of switching a reception direction of the first antenna; and
a reception direction setting unit for setting a reception direction in which an optimum reception state can be obtained based on the reception levels in a plurality of reception directions detected by the detection unit when the reception direction switching unit sequentially changes the reception direction of the first antenna, wherein
the control unit, to the broadcast signals of the UHF band, makes the selection unit select the first antenna and makes the channel setting unit set the channels and the reception directions of the broadcast signals, and, to the broadcast signal of the VHF band, makes the selection unit select the second antenna and makes the channel setting unit set the channel of the broadcast signal.

2. A television broadcast signal reception apparatus connected to an antenna apparatus including a first antenna capable of receiving a broadcast signal of a first frequency band, and a second antenna capable of receiving a broadcast signal of a second frequency band, the television broadcast signal reception apparatus comprising:
a selection unit for selecting either of the first antenna and the second antenna correspondingly to a frequency of a received broadcast signal;
a detection unit for detecting a reception level of a reception signal received by the first antenna or the second antenna;
a channel setting unit for setting a channel of a broadcast signal having the reception level equal to a predetermined level or more, the reception level detected by the detection unit, as a receivable channel; and
a control unit for controlling operations of the selection unit, the detection unit, and the channel setting unit, wherein
the channel setting unit includes:
a reception direction switching unit capable of switching the reception direction of the first antenna; and
a reception direction setting unit for setting a reception direction in which an optimum reception state can be obtained based on the reception levels in a plurality of reception directions, the reception levels detected by the detection unit when the reception direction of the first antenna is sequentially changed by the reception direction switching unit, wherein
the control unit, to the broadcast signal of the first frequency band, makes the selection unit select the first antenna and makes the channel setting unit set the channel and the reception direction of the broadcast signal, and, to the broadcast signal of the second frequency band, makes the selection unit select the second antenna and makes the channel setting unit set the channel of the broadcast signal.

3. The television broadcast signal reception apparatus according to claim 2, wherein the first antenna is a multi-directivity antenna capable of changing its reception direction, and
the second antenna is a unidirectional antenna capable of receiving the broadcast signal from a single direction.

4. The television broadcast signal reception apparatus according to claim 2, wherein the second antenna is configured to be able to change the directivity by hand.

5. The television broadcast signal reception apparatus according to claim 3, wherein the second antenna is configured to be able to change the directivity by hand.

6. The television broadcast signal reception apparatus according to claim 2, wherein the first frequency band is one equivalent to the UHF band, and
the second frequency band is one equivalent to the VHF band.

7. The television broadcast signal reception apparatus according to claim 3, wherein the first frequency band is one equivalent to the UHF band, and
the second frequency band is one equivalent to the VHF band.

8. The television broadcast signal reception apparatus according to claim 4, wherein the first frequency band is one equivalent to the UHF band, and
the second frequency band is one equivalent to the VHF band.

9. The television broadcast signal reception apparatus according to claim 5, wherein the first frequency band is one equivalent to the UHF band, and
the second frequency band is one equivalent to the VHF band.

10. The television broadcast signal reception apparatus according to claim 2, wherein frequency ranges of the first frequency band and the second frequency band can be arbitrarily set.

11. The television broadcast signal reception apparatus according to claim 3, wherein frequency ranges of the first frequency band and the second frequency band can be arbitrarily set.

12. The television broadcast signal reception apparatus according to claim 4, wherein frequency ranges of the first frequency band and the second frequency band can be arbitrarily set.

13. The television broadcast signal reception apparatus according to claim 5, wherein frequency ranges of the first frequency band and the second frequency band can be arbitrarily set.

14. An antenna apparatus comprising:
a multi-directivity antenna capable of receiving broadcast signals of a first frequency band from many directions; and
a unidirectional antenna capable of receiving a broadcast signal of a second frequency band from a single direction, wherein
the antenna apparatus is connected to a television broadcast signal reception apparatus including:
a first switching unit for enabling selection control of the antennas receiving the broadcast signals by means of the television broadcast signal reception apparatus, and
a second switching unit for enabling switching control of reception directions of the multi-directivity antenna.

15. The antenna apparatus according to claim 14, wherein the unidirectional antenna is configured to be able to change its directivity by hand.
